(19) United States
(12) Patent Application Publication
(10) Pub. No.: US 2008/0267681 A1
(43) Pub. Date: Oct. 30, 2008

(54) IMAGE PRINTING APPARATUS AND IMAGE PRINTING METHOD

(75) Inventors: Toshiyuki Nagasawa, Kanagawa (JP); Koichi Sawada, Kanagawa (JP); Shigenobu Ohga, Kanagawa (JP); Hirotaka Kano, Kanagawa (JP); Jun Matsuoka, Kanagawa (JP); Uko Yamasaki, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/108,648

(22) Filed: Apr. 24, 2008

(30) Foreign Application Priority Data
Apr. 27, 2007 (JP) 2007-119964

(51) Int. Cl. B41J 11/44

(52) U.S. Cl. 400/76

(57) ABSTRACT

An image printing apparatus includes a lottery drawing unit that draws a lottery on the basis of data included in image data to be printed; a maximum-number determining unit that determines whether the number of winners drawn by the lottery drawing unit is less than or equal to a maximum number of winners indicated by data; a storage unit that stores a frame in accordance with a lottery result obtained by the lottery drawing unit; and a printing unit that prints the image data and the frame in a superimposed manner. When the number of winners is determined to be less than or equal to the maximum number of winners, the lottery drawing unit draws a lottery on the basis of data included in image data to be printed. The printing unit prints the image data and the frame in accordance with a lottery result in a superimposed manner.

### CROSS REFERENCES TO RELATED APPLICATIONS

The present invention contains subject matter related to Japanese Patent Application JP 2007-119964 filed in the Japanese Patent Office on Apr. 27, 2007, the entire contents of which are incorporated herein by reference.

### BACKGROUND OF THE INVENTION

1. Field of the Invention

The present invention relates to an image printing apparatus and an image printing method for drawing a lottery when printing images and giving prizes to winners.

2. Description of the Related Art

Sublimation printing apparatuses are expected to generate high-quality print results. Therefore, these sublimation printing apparatuses are often used as professional-quality printing equipment at parties, events, and places including theme parks, tourist sites, and print shops. In many cases, these professional-quality printing apparatuses are used not only to earn a profit from selling photographs, but also to serve as one of tools to promote sales. For example, the professional-quality printing apparatuses are used to provide advertising services by, for example, combining a graphic symbol such as an advertisement of a sponsor or a coupon with a photographic image of a visitor that has been captured at an event site, printing a hard copy of the combined images, and giving the hard copy as a gift to the visitor. These services are more economical than distributing souvenirs to visitors. Because the printed hard copy can be regarded as a custom-made gift that is limited to that visitor, these services serve as a sales promoting method that appeals to visitors in an efficient manner.

Furthermore, in order to attract more customers to an event, there are professional-quality printing apparatuses that can provide lottery drawing services when distributing photographic gifts. With these printing apparatuses, events can be more entertaining, and the anticipation and mood of visitors can be enhanced and become more exciting. Accordingly, the attention of the visitors can be directed more to the event, thereby providing promising sales promoting effects. More specifically, a “winning” symbol is added to one in a certain number of photographs to be given as gifts. This “winning” symbol, which is prepared in advance, can be combined with the photograph or printed in an empty space or on the back of the photograph (see Japanese Unexamined Patent Application Publication No. 2005-74779).

Printing apparatuses with this lottery drawing function combine a graphic symbol such as an advertisement of a sponsor or a coupon with a desired photographic image of a visitor, add a winning symbol indicating that the visitor is a winner in accordance with a predetermined winning condition, and print a hard copy of the combined images. However, if there are too many “winners”, there may be an inconvenience, such as a shortage of prizes given as gifts. When a lottery is drawn at an event, the event may be more entertaining if the probability of winning is changeable according to the purpose of the event.

If the winning condition has been set so that a “winner” is drawn at a rate of one in every predetermined number of lots, winning or losing can be roughly predicted, and control over the progress of the event can be easily provided. However, there will be no chances of consecutive “winners”. If the mechanism of this lottery may be disclosed to visitors, the anticipation of the visitors may become less, and the visitors may eventually lose interest in the lottery.

### SUMMARY OF THE INVENTION

It is desirable to provide an image printing apparatus and an image printing method for providing easy control over the number of prizes to be given to winners by operating a lottery so that the number of winners in the lottery can be less than or equal to a predetermined maximum number of winners.

It is also desirable to provide an image printing apparatus and an image printing method for drawing a lottery in accordance with image data by drawing lots on the basis of information included in the image data, thereby making the lottery more entertaining.

An image printing apparatus according to an embodiment of the present invention is an image printing apparatus including the following elements: lottery drawing means for drawing a lottery on the basis of data included in image data to be printed; maximum-number determining means for determining whether the number of winners drawn by the lottery drawing means is less than or equal to a maximum number of winners indicated by data indicating the maximum number of winners; storage means for storing a frame in accordance with a lottery result obtained by the lottery drawing means; and printing means for printing the image data to be printed and the frame in accordance with the lottery result in a superimposed manner. In a case where the maximum-number determining means determines that the number of winners is less than or equal to the maximum number of winners, the lottery drawing means draws a lottery on the basis of data included in image data to be printed by the printing means. The printing means prints the image data to be printed and the frame in accordance with a lottery result obtained by the lottery drawing means in a superimposed manner.

According to another embodiment of the present invention, there is provided an image printing method using the image printing apparatus.

According to the embodiments of the present invention, whether the number of winners is less than or equal to the maximum number of winners is determined. If the number of winners is less than or equal to the maximum number of winners, a lottery is drawn, and image data to be printed and a frame in accordance with a lottery result are printed in a superimposed manner. Accordingly, control over the number of prizes to be given to winners can be easily provided. Since a lottery is drawn on the basis of data included in the image data to be printed, the lottery becomes more entertaining.

### BRIEF DESCRIPTION OF THE DRAWINGS

FIG. 1 is a perspective view of an image printing apparatus according to an embodiment of the present invention;

FIG. 2 is a block diagram of the image printing apparatus according to the embodiment of the present invention;

FIGS. 3A to 3E are illustrations of examples of an image combined with a winning frame, that is, FIG. 3A illustrates the original image, and FIGS. 3B to 3E illustrate examples of the image combined with the winning frame;

FIG. 4 is a flowchart showing a process including a series of steps of receiving image data input from a user, drawing a lottery, and printing the image data; and

FIG. 5 is a flowchart showing a process of drawing a lottery.

### DESCRIPTION OF THE PREFERRED EMBODIMENTS

An image printing apparatus according to an embodiment of the present invention will now herein be described with reference to the drawings.

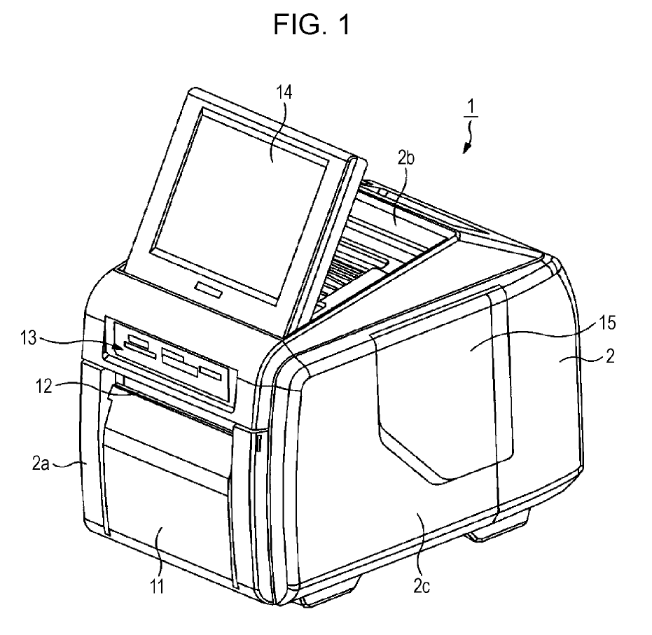

Referring to FIG. 1, an image printing apparatus 1 according to an embodiment of the present invention is a thermal head printer that brings an ink ribbon into contact with printer paper, and applies heat energy using a thermal head so that ink, such as sublimation dye or the like, formed on the ink ribbon sublimates and an image is transferred to a predetermined area of a roll sheet. The image is thus formed. In the image printing apparatus 1, long printer paper is wound on a roll and is accommodated in an apparatus main body 2. An image is formed on printer paper pulled out of the roll, and then the paper is cut into a predetermined size and ejected. Accordingly, a desired photograph can be obtained. The apparatus main body 2 contains a conveying mechanism for pulling printer paper from the roll and conveying the printer paper, a thermal head for forming an image on the printer paper, a cut-out unit for cutting the printer paper on which the image is printed into a predetermined size, and the like.

A door panel 11, a paper-ejecting opening 12 through which the printed printer paper is ejected, and an image input interface unit 13 including recording-media slots into which recording media recording images can be inserted and universal serial bus (USB) ports are provided on a front face 2a of the apparatus main body 2. The door panel 11 is formed so as to be rotatable in a forward direction about a bottom part of the front face 2a. When the interior of the apparatus main body 2 is opened, a holder for accommodating a roll of printer paper is released so that a roll of printer paper can be accommodated. After a roll sheet of printer paper on which an image is printed is cut into a predetermined size, the cut roll sheet is ejected to the outside of the apparatus main body 2 through the paper-ejecting opening 12 using the conveying mechanism. The image input interface unit 13 includes slots into which various recording media having different sizes and shapes can be inserted and USB ports. One or more pieces of image data recorded in a recording medium or a recording medium in a recorder, such as a digital still camera or a digital video camera, connected to the image printing apparatus 1 via USB are input to the image printing apparatus 1 so that the input piece(s) of image data can be checked and printed.

A liquid crystal display (LCD) panel 14 is provided on a top face 2b of the apparatus main body 2. The LCD panel 14 displays thumbnails of images input to the image printing apparatus 1 via the image input interface unit 13. At the same time, the LCD panel 14 serves as a touch panel for entering various operations, such as selecting an image to be printed, the number of hard copies, and starting a printing operation. The LCD panel 14 is formed as a substantially rectangular shape. The LCD panel 14 is formed to be rotatable toward the front face 2a about an edge part facing the front face 2a. The apparatus main body 2 includes a ribbon door 15 on a side face 2c for attaching/removing an ink ribbon.

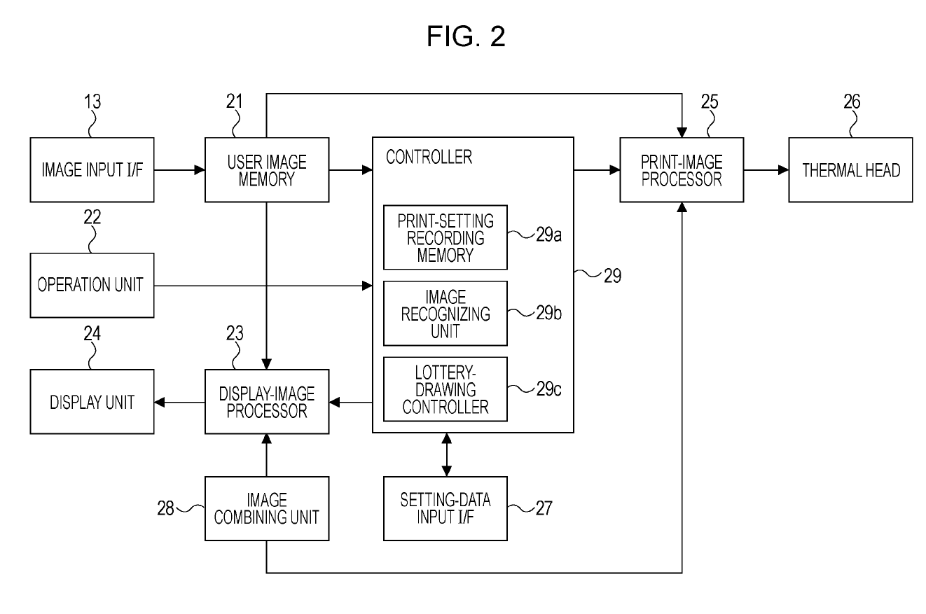

Referring now to FIG. 2, the circuit configuration of the image printing apparatus 1 will be described. The image printing apparatus 1 includes the image input interface unit 13 to which one or more pieces of image data are input from a recording medium of a user who is now trying to print the piece(s) of image data or from a recorder via USB, a user image memory 21 that temporarily stores the piece(s) of image data input from the image input interface unit 13, an operation unit 22 provided on the LCD panel 14 serving as the foregoing touch panel, a display-image processor 23 that performs display-image processing for displaying the piece(s) of image data input from the image input interface unit 13, a display unit 24 including the foregoing LCD panel 14, a print-image processor 25 that generates print data to be printed, and a thermal head 26 that uses heat to transfer sublimation ink of an ink ribbon to a predetermined area of printer paper.

Pieces of image data in various file formats including the Joint Photographic Experts Group (JPEG), the Tagged Image File Format (TIFF), the Graphics Interchange Format (GIF), and the Exchangeable Image File Format (EXIF) are input from the image input interface unit 13. An EXIF file is in an image file format based on the JPEG image data format and enables embedding of a thumbnail image, image capturing information, or the like.

With the operation unit 22, a piece(s) of image data can be selected from among pieces of image data displayed as thumbnails on the display unit 24 using the touch panel, and an operation for performing printing can be entered. The operation unit 22 generates various operation signals.

The display-image processor 23 reads a piece(s) of image data input from the image input interface unit 13 from the user image memory 21, generates display data for displaying a thumbnail(s) of the piece(s) of image data, and displays the thumbnail(s) on the display unit 24. For example, when a printing operation for printing a piece of image data that has been selected by the user is performed, the display-image processor 23 displays the piece of image data to be printed on the display unit 24. When displaying the piece of image data to be printed, the display-image processor 23 combines a winning frame or a losing frame with the piece of image data to be printed according to whether the piece of image data to be printed is a winner or a loser so that the winning/losing result can be indicated to the user and displays combined image data on the display unit 24.

The print-image processor 25 converts a piece(s) of image data to be printed into print data. More specifically, the print-image processor 25 receives input of image data one piece at a time, applies color conversion processing on the piece of image data to convert the image data into YMC colors that are the colors of ink, and performs predetermined processing including gamma conversion processing in accordance with coloring characteristics of the printer paper. The thermal head 26 applies heat energy to an ink ribbon with a panel sequential coating having ink of yellow (Y), magenta (M), and cyan (C) and a laminate film (L) to form a color image in a predetermined area of the recording paper and eventually transfers the laminate film to the color image formed on the recording paper.

The image printing apparatus 1 further includes a setting-data input interface unit 27 connectable to a recording medium storing various types of setting data for drawing a lottery, an image combining unit 28 that combines a winning frame, a losing frame, advertisement data of a sponsor, or the like with image data, and a controller 29 that controls the overall operation.

The controller 29 controls the overall operation by performing arithmetic operations based on operation signals input from the operation unit 22, setting data input from the setting-data input interface unit 27, and the like. The controller 29 contains a print-setting recording memory 29a that stores a print result, an image recognizing unit 29b that recognizes an image of image data to be printed, and a lottery-drawing controller 29c that performs a lottery process when printing the image data.

When a recording medium such as an integrated circuit (IC) card or an optical disk is inserted into the setting-data input interface unit 27, the setting-data input interface unit 27 inputs setting data stored in the recording medium to the controller 29. The setting data includes, for example, probability data for drawing a winner, a winning frame and a losing frame to be combined with image data to be printed, data indicating the maximum number of winners, advertisement data of a sponsor, and data indicating a lottery method. For example, a winning frame or a losing frame is read into the image combining unit 28 when image data to be printed is determined to be a winner or a loser using the lottery-drawing controller 29c and is combined with the image data to be printed. When printing the image data, advertisement data of a sponsor is combined with the image data to be printed.

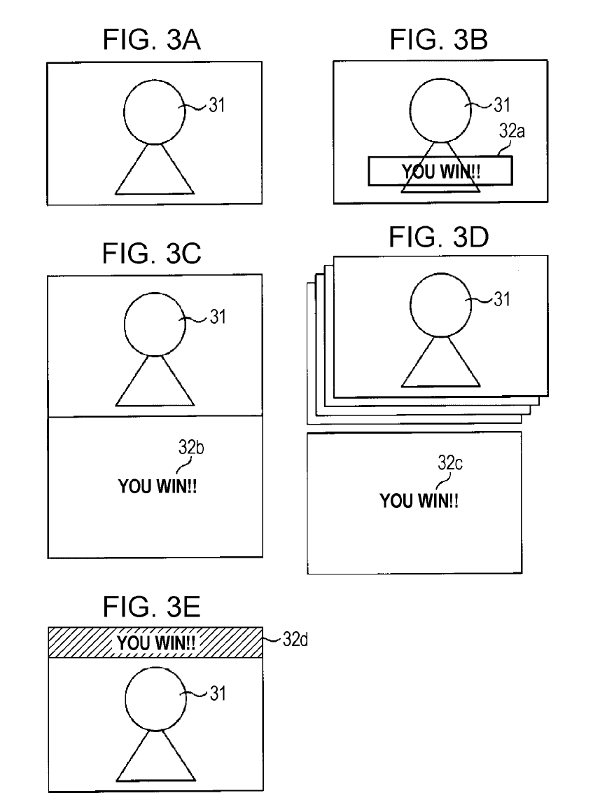

The image combining unit 28 combines or superimposes a winning frame or a losing frame input from the setting-data input interface unit 27 on image data to be printed. For example, as shown in FIG. 3A, it is assumed that image data to be printed is an image 31 of a person in which a circle and a triangle are combined to represent the person. FIG. 3B illustrates a first example in which the image combining unit 28 performs a combining operation of combining a winning frame 32a showing “You win!!” with the image 31. In this case, the winning frame 32a may be translucent so that the image 31 behind the winning frame 32a may be visible through the winning frame 32a. Alternatively, the winning frame 32a may be opaque so that part of the image 31 may be invisible. FIG. 3C illustrates a second example in which the image combining unit 28 combines a winning frame 32b with the image 31 such that the winning frame 32b will not be superimposed on the image 31. Rather, the winning frame 32b is printed on the bottom half of a ticket. Furthermore, FIG. 3D illustrates a third example in which the image combining unit 28 combines a winning frame 32c with the image 31 so that the winning frame 32c will not be superimposed on the image 31. Rather, the winning frame 32c is printed on a separate ticket. In this case, a ticket containing the image 31 and a ticket containing the winning frame 32c are separated from each other by cutting a hard copy of the image 31 and the winning frame 32c with a cutter provided near the paper-ejecting opening 12 of the image printing apparatus 1. Furthermore, FIG. 3E illustrates a fourth example in which the image combining unit 28 combines a winning frame 32d with the image 31 so that the winning frame 32d will not be superimposed on the image 31. Rather, the winning frame 32e is placed on top of the image 31.

The cases illustrated in FIGS. 3A to 3E have been described using the winning frames 32a to 32d by way of example. For a losing frame, “You win!!” in the winning frames 32a to 32d may be changed to “You lose!!” or the like. Alternatively, as shown in FIG. 3A, no losing frame may be combined with the image 31.

The print-setting recording memory 29a records and updates log data including the winning/losing result, lottery date, the number of winners, the number of copies printed, and the like. A non-volatile memory is used for the print-setting recording memory 29a so that no log data will be deleted when power is turned off or in case of errors. Accordingly, after the image printing apparatus 1 is rebooted, the image printing apparatus 1 can resume operation from the state before rebooting. In addition, the setting data and the lottery method input from the setting-data input interface unit 27 may be stored, that is, installed, into the print-setting recording memory 29a.

The image recognizing unit 29b recognizes and analyzes pieces of image data in various formats including JPEG, TIFF, GIF, and EXIF, which are input from the image input interface unit 13 to the user image memory 21 so that the pieces of image data can be printed. For example, the image recognizing unit 29b analyzes and extracts color values of red (R), green (G), and blue (B) at a predetermined position in image data. The image recognizing unit 29b extracts, from a header of an EXIF file, image-capturing-related data including the image capturing date, the name of the image capturing device, the shutter speed, and the diaphragm stop setting, image-related data including the compression mode for correctly reading main image data, color space, and the number of pixels, and thumbnail data for use in displaying a thumbnail. The image recognizing unit 29b performs a face recognition on image data to be printed and detects the number of people included in the image data. One or more pieces of data analyzed and detected using the image recognizing unit 29b are used for drawing a lottery.

The lottery-drawing controller 29c gains access to the print-setting recording memory 29a. At first, the lottery-drawing controller 29c obtains data indicating the number of winners, which is included in the log data, and data indicating the maximum number of winners, which is included in the setting data, and determines whether the current number of winners is less than or equal to the maximum number of winners. If the current number of winners is less than or equal to the maximum number of winners, the lottery-drawing controller 29c performs a lottery process. Accordingly, for example, a person in charge of the lottery can correctly predict the number of prizes to be prepared for users who win the lottery.

More specifically, the lottery-drawing controller 29c gains access to the print-setting recording memory 29a and draws a lottery according to the lottery method that has been currently set.

In normal operation, the lottery-drawing controller 29c draws a lottery based on a predetermined random number table (random number formula). For example, the following is performed.

(1) A division is performed by changing a modulus, and the remainder of the division is evaluated. If the remainder is “0”, it is regarded that a “winner” has been drawn.

(2) The value of the remainder is set in advance for a first prize and the like. If the remainder is “0”, a first prize is won; if the remainder is “1” or “2”, a second prize is won.

Although the lottery-drawing controller 29c may use one predetermined random number table (random number formula), as will be described later, the lottery-drawing controller 29c may select a random number table (random number formula) on the basis of data included in image data such that the probability of winning, that is, how often a prize is won, can be changed.

(3) Using the color values of R, G, and B at a predetermined position, which are extracted by analyzing image data to be printed using the image recognizing unit 29b, the lottery-drawing controller 29c selects a random number table (random number formula) with a higher probability of winning if one or more of the color values of R, G, and B at the predetermined position are greater than or equal to a preset threshold.

(4) The lottery-drawing controller 29c selects a random number table (random number formula) with a higher probability of winning if specific data included in the header of an EXIF file, which has been extracted by analyzing the image data to be printed using the image recognizing unit 29b, corresponds to predetermined data. For example, if the name of the image capturing device corresponds to a predetermined device name, or if the image capturing date is before or after a specific date, the lottery-drawing controller 29c selects a random number table (random number formula) with a higher probability of winning.

(5) The lottery-drawing controller 29c determines whether the number of people included in the image data, which has been extracted by analyzing the image data to be printed using the image recognizing unit 29b, is greater than or equal to a predetermined number of people. If the number of people included in the image data is greater than or equal to or less than or equal to the predetermined number of people, the lottery-drawing controller 29c selects a random number table (random number formula) with a higher probability of winning.

(6) The lottery-drawing controller 29c selects a random number table (random number formula) with a higher probability of winning if a specific pattern of the image data to be printed, which has been extracted using the image recognizing unit 29b, is similar to a preset pattern, that is, if the difference between the two patterns is less than or equal to a predetermined value.

(7) The lottery-drawing controller 29c selects a random number table (random number formula) with a higher probability of winning if image quality data, such as whether the image data to be printed includes red eyes, whether the image data to be printed has been captured against the sun, or whether the image data to be printed is overexposed or underexposed, which has been extracted using the image recognizing unit 29b, is less than or equal to or greater than or equal to a predetermined value, that is, if image capturing has been done at a level greater than or less than a predetermined level.

Alternatively, as will be described in (8) to (10) below, the lottery-drawing controller 29c may change the probability of winning, that is, how often a prize is won, by selecting a random number table (random number formula) on the basis of print-related data that is data other than data included in the image data.

(8) The lottery-drawing controller 29c selects a random number table (random number formula) with a higher probability of winning if the current time at which a print order is issued, which has been obtained by the controller 29 on the basis of an internal timer, is within a predetermined time interval (e.g., from 9 AM to 12 PM).

(9) The lottery-drawing controller 29c selects a random number table (random number formula) with a higher probability of winning if the number of types of image data selected by the user to be printed (excluding the case where multiple copies of the same piece of image data are to be printed) is greater than or equal to or less than or equal to a predetermined number.

(10) The lottery-drawing controller 29c selects a random number table (random number formula) with a higher probability of winning if image data input from the image input interface unit 13 has been input through a recording medium slot or a USB port.

If different prizes including first, second, . . . prizes are to be given to winners, in (3) to (10) described above, the lottery-drawing controller 29c selects a random number table (random number formula) with which higher prizes, such as first prizes or the highest prizes, are more often won. Alternatively, if predetermined conditions in (3) to (10) are satisfied, the lottery-drawing controller 29c may determine that that piece of image data is a winner instead of selecting a random number table (random number formula) with a higher probability of winning.

Instead of performing (1) to (10) described above, the lottery-drawing controller 29c may draw a lottery in accordance with (11) described below:

(11) If a winner is simply drawn at a rate of one in a certain number of hard copies according to the modulus, no “winner” may be drawn for an indefinite period of time with not a small probability. When distributing prizes, the person in charge of a lottery may want to surely draw a “winner” at a rate in one in every predetermined number of copies printed. To this end, a “winner” may be drawn on the basis of the number of copies printed. For example, if it is assumed that one in ten copies wins a prize, the probability is initially controlled according to the progress of printing as in 1/10, 1/9, ⅛ . . . . After a “winner” is drawn, no winner will be drawn until ten copies are completely printed. Thus, there is one “winner” in ten copies. In such a case, no two consecutive “winners” are drawn in ten copies. If this mechanism is disclosed to visitors, the anticipation of the visitors in terms of sales promotion may become less. To overcome such a situation, a lottery is drawn using the following method taking into consideration the possibility of successive winners.

Provided that there is one “winner” in ten copies, it is assumed that three successive winners are allowed. In this case, initially the probability is controlled according to the number of copies printed, as in 1/10, 1/9, ⅛ . . . . If a “winner” is drawn, the number of copies that falls short of ten copies is used for the next calculation. For example, if the fifth copy is a winner, the probability of drawing the subsequent “winner” is set to 1/15, 1/14, 1/13 . . . . After three winners are drawn, no “winner” will be drawn until 10×3 (30) copies are printed in total.

That is, the probability of winning is set to one in n lots. In the case where a t-th lot is determined to be an S-th winner, if t<S-n, the probability of drawing the next winner or the (S+1)-th winner is reduced so that there will be one winner in (S·n−t+n) lots. Accordingly, the chances of consecutive winners are maintained on one hand, and a desired number of “winners” are dispersed throughout all the copies.

Furthermore, for the winners drawn using the method in (11), the lottery methods (1) to (10) may be additionally employed. Alternatively, the lottery methods (1) to (10) may be employed to determine first, second, . . . prizes.

Next, a process including a series of steps of receiving image data input from a user, drawing a lottery, and printing the image data, which is performed using the image printing apparatus 1 with the foregoing configuration, will be described.

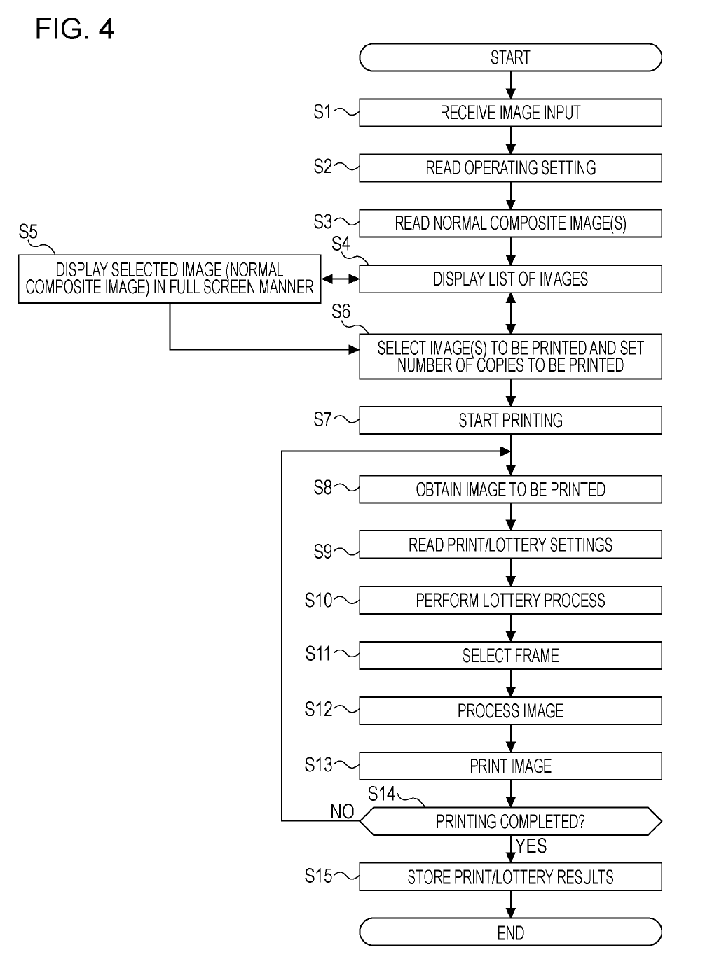

Referring to FIG. 4, when the user connects a recording medium to the image input interface unit 13, the controller 29 in step S1 reads one or more pieces of image data from the recording medium connected to the image input interface unit 13 into the user image memory 21. At the same time, the controller 29 in step S2 reads setting data for operation settings from a recording medium connected to the setting-data input interface unit 27 and loads the setting data into the print-setting recording memory 29a. For example, among pieces of setting data stored in the recording medium, setting data indicating whether to perform a lottery process, advertisement data, and the like are read into the print-setting recording memory 29a.

In step S3, the controller 29 outputs the piece(s) of image data input from the image input interface unit 13 and, among the pieces of setting data loaded into the print-setting recording memory 29a, the advertisement data to the image combining unit 28. The image combining unit 28 generates a thumbnail image(s) of the piece(s) of image data and combines or superimposes the advertisement data on each of the thumbnail image(s). In step S4, a list of a piece(s) of image data of the thumbnail image(s) with the advertisement data combined or superimposed thereon is displayed on the display unit 24. Since an EXIF file contains a thumbnail image, the advertisement data is combined or superimposed on this thumbnail image. Alternatively, the advertisement data may be combined or superimposed on each page displaying a list of thumbnail images, instead of combining the advertisement data on each thumbnail image.

In a state where the list is displayed on the display unit 24, the user operates the operation unit 22 which is a touch panel to select one thumbnail image. In step S5, the controller 29 displays the selected image data on the display unit 24 in a full screen manner.

In step S6, the user operates the operation unit 22 to select a piece(s) of image data to be printed. In step S7, the controller 29 sequentially starts printing the piece(s) of image data selected by the user. In step S8, the controller 29 obtains one piece of image data selected to be printed from the user image memory 21 or from the recording medium connected to the image input interface unit 13, and performs processing to obtain data necessary for drawing a lottery using the image recognizing unit 29b. More specifically, the foregoing processing in (3) to (7) is performed. For example, in (3), color values of R, G, and B at a predetermined position are extracted. In (4), specific data included in the header of the EXIF file is extracted. In (5), the number of people included in the image data is extracted.

In step S9, the controller 29 loads the setting data, such as data indicating a lottery method and data indicating the maximum number of winners, from the setting-data input interface unit 27 into the print-setting recording memory 29a. In step S10, the lottery-drawing controller 29c performs a predetermined lottery process to determine whether the image data to be printed is a winner or a loser or has won any of first, second, . . . prizes.

When determination of whether the image data to be printed is a winner or a loser or has won any prize is made, in step S11, the controller 29 selects a winning frame or a losing frame or, depending on circumstances, a prize frame indicating a corresponding prize from the recording medium via the setting-data input interface unit 27 or, when the setting data has been loaded into the print-setting recording memory 29a, from the print-setting recording memory 29a, and outputs the selected frame to the image combining unit 28.

In step S12, the controller 29 uses the image combining unit 28 to combine or superimpose the winning frame or the losing frame or, depending on circumstances, the prize frame indicating a corresponding prize on the image data to be printed, as shown in FIGS. 3A to 3E, and combines or superimposes the advertisement data, which is one piece of the setting data, on the image data to be printed. The image combining unit 28 outputs composite image data generated by superimposing the winning/losing frame and the advertisement data on the image data to be printed to the print-image processor 25.

In step S13, the controller 29 performs processing to convert the colors into a YMC color space, gamma conversion processing, and the like using the print-image processor 25 to convert the image data to be printed into print data, drives the thermal head 26 on the basis of the generated print data to transfer ink in order of yellow, magenta, and cyan to recording paper conveyed, and further uses heat to transfer laminate to a color image formed thereby. The printer paper on which the image has been printed is ejected through the paper-ejecting opening 12. In this manner, the image is printed on printer paper and ejected, as shown in FIGS. 3A to 3E.

In step S14, the controller 29 determines whether all the piece(s) of image data specified by the user to be printed have been completely printed. If the printing is not completed, the flow returns to step S8. If the printing is completed, the flow proceeds to step S15.

In step S15, the controller 29 updates log data in the print-setting recording memory 29a if a winner is drawn. For example, if a winner is drawn, the controller 29 adds one to the number of winners. If printing of one image is completed, the controller 29 adds one to the number of copies printed.

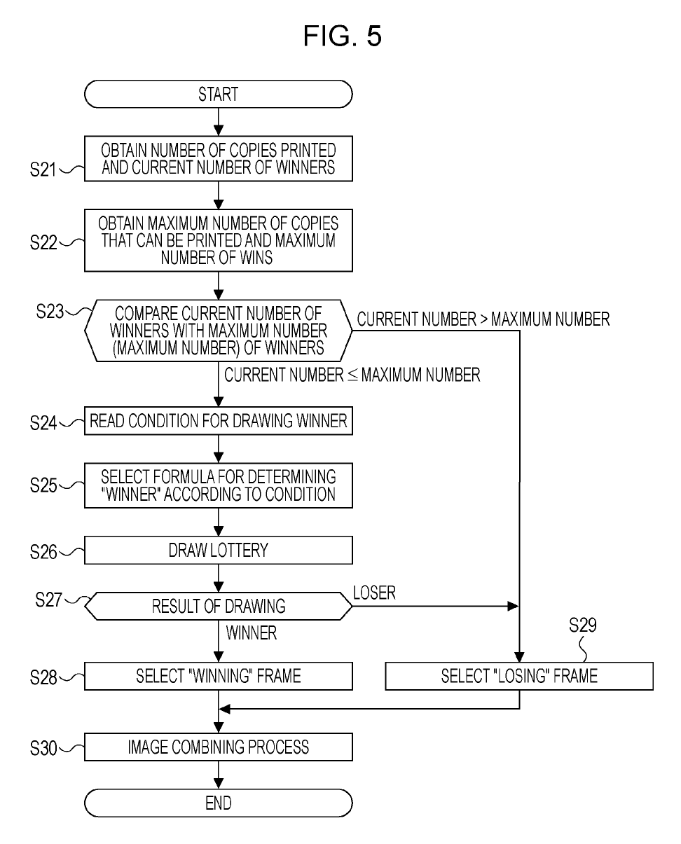

Referring to FIG. 5, the lottery process in steps S9 to S12 of FIG. 4 as has been described above will be described. More specifically, in step S21, the controller 29 reads the data indicating the number of copies printed and the data indicating the current number of winners from the print-setting recording memory 29a. In step S22, the controller 29 obtains data indicating the number of copies that can be printed, which is obtained by subtracting the current number of copies printed from the preset number of copies that can be printed, the data indicating the maximum number of winners, and the like from the print-setting recording memory 29a. In step S23, the controller 29 compares the data indicating the current number of winners with the data indicating the maximum number of winners, which are obtained from the print-setting recording memory 29a, and determines whether the current number of winners is less than or equal to the maximum number of winners. If the current number of winners is less than or equal to the maximum number of winners, the flow proceeds to step S24 so that the controller 29 can perform a lottery process. If the current number of winners is greater than the maximum number of winners, the flow proceeds to step S29. The controller 29 determines that the print data to be printed is a loser and selects the losing frame.

In step S24, the controller 29 reads a condition for drawing a winner, which has been read into the lottery-drawing controller 29c. That is, in step S8, the controller 29 obtains data necessary for drawing a lottery, which has been obtained using the image recognizing unit 29b. For example, in (3) described above, the controller 29 reads color values of R, G, and B at a predetermined position. In (4) described above, the controller 29 reads specific data included in the header of the EXIF file. In (5) described above, the controller 29 reads the number of people included in the image data.

In step S25, the lottery-drawing controller 29c selects a determination formula according to the condition for drawing a winner, that is, a random number table (random number formula). In step S26, the lottery-drawing controller 29c draws a lottery. For example, in (3) described above, if one or more of the color values of R, G, and B at a predetermined position are greater than or equal to a preset threshold, a random number table (random number formula) with a higher probability of winning is selected, and a lottery is drawn using the method in (1) described above. In (4) described above, if the specific data included in the header of the EXIF file, such as the device name, corresponds to a predetermined device name, a random number table (random number formula) with a higher probability of winning is selected, and a lottery is drawn using the method in (1) described above. Further, in (5) described above, whether the number of people included in the image data is greater than or equal to a predetermined number of people is determined. If the number of people included in the image data is greater than or equal to the predetermined number or less than or equal to the predetermined number, a random number table (random number formula) with a higher probability of winning is selected, and a lottery is drawn using the method in (1) described above.

In step S25, the lottery-drawing controller 29c determines whether each of the image(s) to be printed is a winner or a loser on the basis of the selected determination formula, that is, the random number table (random number formula). In step S27, the controller 29 determines whether the determination made by the lottery-drawing controller 29c indicates that the image is a winner or a loser. If the image is a winner, the flow proceeds to step S28; if the image is a loser, the flow proceeds to step S29.

If the image is a winner, in step S28, the controller 29 selects the winning frame from the recording medium via the setting-data input interface unit 27 or, if the setting data has been loaded into the controller 29, from the print-setting recording memory 29a.

If the image is a loser, in step S29, the controller 29 obtains the losing frame from the recording medium via the setting-data input interface unit 27 or, if the setting data has been loaded into the controller 29, from the print-setting recording memory 29a. Alternatively, if the image is a loser, no loser frame may be combined with the image, and only the advertisement data may be combined or superimposed on the image.

In step S30, the controller 29 combines or superimposes the winning frame or the losing frame on the image data to be printed and combines or superimposes the advertisement data, which is one piece of the setting data, on the image data to be printed using the image combining unit 28. The image combining unit 28 outputs composite image data generated by superimposing the winning/losing frame and the advertisement data on the image data to be printed to the print-image processor 25 so that the composite image data is printed.

In the example shown in FIG. 5, the case in which the determination formula, that is, the random number table (random number formula), is selected on the basis of data included in image data has been described. Alternatively, for example, the lottery process in (11) described above may be performed in steps S24 to S26 of FIG. 5 regardless of the data included in the image data.

In the example in (11) described above, after the controller 29 checks in step S23 the maximum number of winners, it is assumed that one in ten images is a winner, and the controller 29 reads the lottery method permitting three consecutive winners from the print-setting recording memory 29a. Initially, the probability is controlled according to the number of copies printed, as in 1/10, 1/9, ⅛ . . . . If a “winner” is drawn, the number of copies that falls short of ten copies is used for the next calculation. For example, if the fifth copy is a winner, the probability of drawing the subsequent “winner” is set to 1/15, 1/14, 1/13 . . . . After three winners are drawn, no “winner” will be drawn until 10×3 (30) copies are printed in total.

That is, the probability of winning is set to one in n lots. In the case where a t-th lot is determined to be an S-th winner, if t<S·n, the probability of drawing the next winner or the (S+1)-th winner is reduced so that there will be one winner in (S·n−t+n) lots.

The lottery-drawing controller 29c controls the probability of winning in the foregoing manner, draws a lottery as in (1) described above, and determines whether each image is a winner or a loser. Accordingly, the chances of consecutive winners are maintained on one hand, and a desired number of “winners” are dispersed throughout all the copies. Thereafter, the controller 29 determines whether the image is a winner or a loser.

Alternatively, in the embodiment of present invention, a primary lottery may be drawn using the foregoing lottery method. That is, the probability of winning is set to one in n lots. In the case where a t-th lot is determined to be an S-th winner, if t<S·n, the probability of drawing the next winner or the (S+1)-th winner is reduced so that there will be one winner in (S·n−t+n) lots. If this piece of image data is determined as a winner, a secondary lottery may be drawn for this winner on the basis of data included in the image data. The method in any one of (8) to (10) described above, instead of (11), may be employed to draw the primary lottery. In the secondary lottery, instead of determining whether the piece of image data is a winner or a loser as in (1) described above, the determination formula, that is, the random number table (random number formula), may be selected on the basis of data included in the image data, and, a prize may be determined on the basis of the selected determination formula, as in (2) described above. That is, a prize may be determined by setting in advance the value of the remainder for a first prize and the like. If the remainder is “0”, a first prize is won; if the remainder is “1” or “2”, a second prize is won. In this manner, control over prizes given to winners can be provided by drawing the primary lottery and the secondary lottery. For example, at an event for promoting sales of cameras manufactured and sold by camera manufacturer A, pieces of image data captured using cameras manufactured by this company A (see (4) described above) can be given higher prizes, such as first and second prizes. Symbols of these prizes are printed on printer paper. Alternatively, instead of printing symbols of the prizes on printer paper, different frame symbols may be printed for different prizes.

In the foregoing example, the case in which the determination formula, that is, the random number table (random number formula), is selected on the basis of data included in image data has been described. Alternatively, in the embodiment of the present invention, winners/losers or prizes may be directly determined on the basis of data included in image data. For example, in (3) described above, if one or more of the color values of R, G, and B at a predetermined position are greater than or equal to a preset threshold, this piece of image data may be determined as a winner. Otherwise, this piece of image data is determined as a loser. If the color whose value is greater than or equal to the threshold is red (R), a first prize is won; if this color is green (G), a second prize is won; and, if this color is blue (B), a third prize is won. Alternatively, in (4) described above, if the specific data included in the header of the EXIF file, such as the device name, corresponds to a predetermined device name, this piece of image data may be determined as a winner. Otherwise, this piece of image data is determined as a loser. If the specific data corresponds to device name “A”, a first prize is won; if the specific data corresponds to device name “B”, a second prize is won; and so forth. Alternatively, in (5) described above, whether the number of people included in the image data is greater than a predetermined number of people is determined. If the number of people included in the image data is greater than or equal to or less than or equal to the predetermined number, the image data is determined as a winner. Otherwise, the image data is determined as a loser. If the number of people included in the image data is three or more, a first prize is won; if the number of people included in the image data is two, a second prize is won; and if only one person is included in the image data, a third prize is won. Symbols of the prizes are printed on printer paper. Alternatively, instead of printing symbols of these prizes on printer paper, different frame symbols may be printed for different prizes.

Besides drawing winners whose number is less than or equal to the maximum number of winners, data indicating the number of copies that can be printed may be included in the setting data so that copies whose number does not exceed the maximum number of printable copies can be printed. If the number of copies printed exceeds this maximum number, no winner may be drawn by compulsion.

Furthermore, if an image to be printed is a winner, besides a winning frame, an additional serial number indicating the number of winners printed or the number of copies printed including winners and losers may be printed on printer paper. In this way, control over the number of pieces of printer paper on which “winners” are printed can be provided, thereby preventing abuse of the same piece of printer paper to receive prizes a number of times.

Although the case where a lottery is drawn every time one piece of photographic image data is obtained and printed has been described in the foregoing examples, the embodiment of the present invention is not limited thereto. For example, a lottery may be drawn every time one order (job) is processed, and winners/losers or prizes may be determined at a predetermined timing using a predetermined method.

In the foregoing examples, the case in which the image combining unit 28 combines or superimposes a winning frame or a losing frame on image data has been described. Alternatively, according to the embodiment of the present invention, in the case where a sublimation printing apparatus using the thermal head 26 is used, the thermal head 26 may use recesses and protrusions to form a winning frame or a losing frame on a laminate, which is to be transferred to an image formed on printer paper using heat. In this case, when the thermal head 26 uses heat to transfer a laminate to printer paper, a winning frame or a losing frame may be output to the print-image processor 25. Accordingly, the winning frame or the losing frame formed on the laminate may be viewed as an embossed surface.

Although the foregoing description concerns the sublimation image printing apparatus 1 by way of example, the embodiment of the present invention is applicable to inkjet printers and laser printers.

It should be understood by those skilled in the art that various modifications, combinations, sub-combinations and alterations may occur depending on design requirements and other factors insofar as they are within the scope of the appended claims or the equivalents thereof.

What is claimed is:

1. An image printing apparatus comprising:
lottery drawing means for drawing a lottery on the basis of data included in image data to be printed;
maximum-number determining means for determining whether the number of winners drawn by the lottery drawing means is less than or equal to a maximum number of winners indicated by data indicating the maximum number of winners;
storage means for storing a frame in accordance with a lottery result obtained by the lottery drawing means; and
printing means for printing the image data to be printed and the frame in accordance with the lottery result in a superimposed manner,
wherein, in a case where the maximum-number determining means determines that the number of winners is less than or equal to the maximum number of winners, the lottery drawing means draws a lottery on the basis of data included in image data to be printed by the printing means, and the printing means prints the image data to be printed and the frame in accordance with a lottery result obtained by the lottery drawing means in a superimposed manner.

2. The image printing apparatus according to claim 1, wherein the lottery drawing means draws a primary lottery and then, as a secondary lottery, a lottery on the basis of data included in image data determined to be a winner.

3. The image printing apparatus according to claim 2, wherein the primary lottery is drawn by setting a probability of winning to one in n lots, and, in a case where a t-th lot is determined to be an S-th winner with the probability of winning, if t<S-n, the probability of drawing a next winner, which is an (S+1)-th winner, is set to one in (S·n−t+n) lots.

4. The image printing apparatus according to claim 1, wherein the data included in the image data includes color values of red, green, and blue at a predetermined position, and
wherein the lottery drawing means draws a winner or a loser according to whether one or more of the color values of red, green, and blue are greater than or equal to a threshold.

5. The image printing apparatus according to claim 1, wherein the data included in the image data is data in the Exchangeable Image File Format, and
wherein the lottery drawing means draws a winner or a loser according to whether specific data included in the data in the Exchangeable Image File Format corresponds to predetermined data.

6. The image printing apparatus according to claim 1, wherein the data included in the image data indicates the number of people included in the image data, and
wherein the lottery drawing means draws a winner or a loser on the basis of the number of people.

7. The image printing apparatus according to claim 1, wherein the printing means prints a color image, forms a laminate layer on the printed color image, and forms the frame in accordance with the lottery result on the laminate layer in an embossed manner.

8. The image printing apparatus according to claim 1, wherein, instead of drawing a lottery using the data included in the image data, the lottery drawing means sets a probability of winning to one in n lots, and, in a case where a t-th lot is determined to be an S-th winner with the probability of winning, if t<S·n, the probability of drawing a next winner, which is an (S+1)-th winner, is set to one in (S·n−t+n) lots.

9. An image printing method using an image printing apparatus including lottery drawing means for drawing a lottery, maximum-number determining means for determining whether the number of winners drawn by the lottery drawing means is less than or equal to a maximum number of winners indicated by data indicating the maximum number of winners, storage means for storing a frame in accordance with a lottery result obtained by the lottery drawing means, and printing means for printing the image data to be printed and the frame in accordance with the lottery result in a superimposed manner, the method comprising the steps of:
determining, using the maximum-number determining means, whether the number of winners is less than or equal to the maximum number of winners;
drawing, with the lottery drawing means, a lottery on the basis of data included in the image data to be printed in a case where the number of winners is less than or equal to the maximum number of winners; and
printing, with the printing means, the image data to be printed and the frame in accordance with the lottery result in a superimposed manner.

10. An image printing apparatus comprising:
a lottery drawing unit configured to draw a lottery on the basis of data included in image data to be printed;
a maximum-number determining unit configured to determine whether the number of winners drawn by the lottery drawing unit is less than or equal to a maximum number of winners indicated by data indicating the maximum number of winners;
a storage unit configured to store a frame in accordance with a lottery result obtained by the lottery drawing unit; and
a printing unit configured to print the image data to be printed and the frame in accordance with the lottery result in a superimposed manner,
wherein, in a case where the maximum-number determining unit determines that the number of winners is less than or equal to the maximum number of winners, the lottery drawing unit draws a lottery on the basis of data included in image data to be printed by the printing unit, and the printing unit prints the image data to be printed and the frame in accordance with a lottery result obtained by the lottery drawing unit in a superimposed manner.
